(19) United States
(12) Patent Application Publication
(10) Pub. No.: US 2008/0104539 A1
(43) Pub. Date: May 1, 2008

(54) Reproducing apparatus, reproducing method, and reproducing system

(75) Inventor: Shingo Ikeda, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/976,263

(22) Filed: Oct. 23, 2007

(30) Foreign Application Priority Data
Oct. 31, 2006 (JP) 2006-297056

(51) Int. Cl. G06F 3/048

(52) U.S. Cl. 715/808

(57) ABSTRACT

According to one embodiment, there is provided a reproducing apparatus including a communication unit which receives a fixed-term content from an external device via a network, a storage unit which stores the fixed-term content in a storage area via the communication unit, an input unit which inputs a warning condition, and a management unit which compares an expiration time of the fixed-term content stored in the storage unit with a current time, and which generates a warning image or a warning sound to be output when a time from the current time to the expiration time satisfies the warning condition input from the input unit.

### CROSS-REFERENCE TO RELATED APPLICATIONS

This application is based upon and claims the benefit of priority from Japanese Patent Application No. 2006-297056, filed Oct. 31, 2006, the entire contents of which are incorporated herein by reference.

### BACKGROUND

1. Field

One embodiment of the present invention relates to a reproducing apparatus and a reproducing method issuing a warning against the expiration of a fixed-term content supplied via a network or the like.

2. Description of the Related Art

Recently, digital equipment has been developed and popularized, and the technology of enhancing convenience by providing additional functions to such digital equipment has been known. For example, a video-on-demand (hereinafter VOD) service using a broadband line has been in widespread use. As the advantage in the VOD service, it is possible to view contents whenever a user wishes to view those, and further to purchase and view only contents that the user wishes to view.

In Patent Document 1 (Jpn. Pat. Appln. KOKAI Publication No. 2002-44555), there is disclosed a reproducing apparatus corresponding to VOD in which information on expiration is provided from a provider or the like supplying contents to be indicated, which enables a user to know whether or not the contents can be reproduced.

However, in the conventional art of the Patent Document 1, information on whether the content is expired or not is merely provided from a provider or the like, and there is the problem that it is impossible to optionally know information which a user wishes to know, for example, whether all the content can be viewed in the case where the user now starts viewing it.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a structure of a reproducing apparatus according to one embodiment of the present invention;

FIG. 2 is a flowchart showing an example of warning process for fixed-term contents in the reproducing apparatus according to one embodiment of the present invention;

FIG. 3 is a flowchart showing an example of another warning process for fixed-term contents of the reproducing apparatus according to one embodiment of the present invention;

FIG. 4 is a flowchart showing an example of yet another warning process for fixed-term contents of the reproducing apparatus according to one embodiment of the present invention;

FIG. 5 is a flowchart showing an example of another warning process with a screen for purchasing fixed-term contents of the reproducing apparatus according to one embodiment of the present invention;

FIG. 6 is an explanatory view showing an example of a contents list screen which the reproducing apparatus according to one embodiment of the present invention displays; and

FIG. 7 is an explanatory view showing an example of a reproducing screen with a warning indication of the reproducing apparatus according to one embodiment of the present invention.

### DETAILED DESCRIPTION

Various embodiments according to the invention will be described hereinafter with reference to the accompanying drawings. In general, according to one embodiment of the invention, there are provided a reproducing apparatus and a reproducing method capable of indicating warning information on contents complying with wishes of a user.

One embodiment for achieving the object is a reproducing apparatus comprising: a communication unit (2) which receives a fixed-term content from an external device via a network; a storage unit (43) which stores the fixed-term content in a storage area via the communication unit; an input unit (32) which inputs a warning condition; and a management unit (42) which compares an expiration time of the fixed-term content stored in the storage unit with a current time, and which generates a warning image or a warning sound to be output when a time from the current time to the expiration time satisfies the warning condition input from the input unit.

In accordance therewith, it is possible to optionally know warning information on the expiration of a fixed-term content complying with wishes of a user, for example, information on whether or not all the fixed-term contents can be reproduced from a current time.

Hereinafter, an embodiment of the present invention will be described in detail with reference to the drawings.

An example of a television apparatus capable of rendering a VOD service, which is one embodiment of the present invention, and by which it is possible to view pay programs through the Internet or the like, will be hereinafter described in detail with reference to the drawings.

### REPRODUCING APPARATUS ACCORDING TO ONE EMBODIMENT OF THE INVENTION

(Structure)

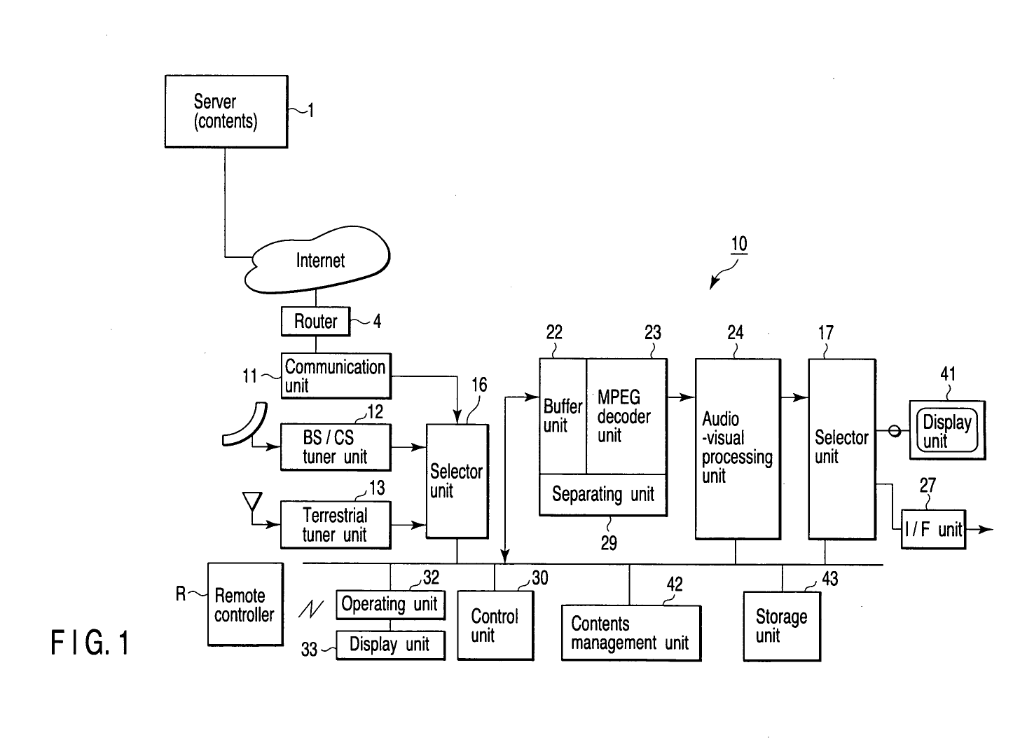

FIG. 1 is a block diagram showing an example of a structure of a reproducing apparatus according to one embodiment of the present invention. In a reproducing apparatus 10 of FIG. 1, a control unit 30 is connected to respective units via a data bus in order to control the operations of the entire apparatus.

Further, the reproducing apparatus 10 of FIG. 1 is mainly composed of an MPEG decoder unit 23 structuring a reproducing side and the control unit 30 controlling the operations of the apparatus body. The reproducing apparatus 10 has a selector 16 at the input side and a selector 17 at the output side. A communication unit 11 having LAN or the like, and a mail function, a so-called satellite broadcast (BS/CS) tuner unit 12, and a so-called terrestrial tuner unit 13 are connected to the selector 16 at the input side. Further, a satellite antenna is connected to the BS/CS tuner unit 12, and a terrestrial antenna is connected to the terrestrial tuner unit 13. Further, the reproducing apparatus 10 includes the MPEG decoder unit 23, an audio-visual output unit 24 performing audio-visual process, a separating unit 29, the control unit 30, a contents management unit 42 managing the expiration times of fixed-term contents described later, and a storage unit 48 storing fixed-term contents or the like into a storage area. These respective units are connected to the control unit 30 via the data bus. Moreover, the output of the selector unit 17 is connected to a display unit 41, and is supplied to an external device via an interface unit 27 which performs communication with the external device.

Moreover, the reproducing apparatus 10 has an operating unit 32 which is connected to the control unit 30 via the data bus, and is operated by a user or a remote controller R. Here, the remote controller R is capable of operating in substantially the same way as the operating unit 32 provided to the main body of the reproducing apparatus 10, and of variously setting for an operation of a tuner and the like.

Moreover, the communication unit 11 of the reproducing apparatus 10 is compatible with a VOD service, and is capable of performing communication via a router device 4 or the like for an optical fiber. The communication unit 11 is capable of acquiring a fixed-term video content which is a pay program in accordance with a request signal from a server 1 or the like, such as a provider after authentication process. The fixed-term video content is stored in the storage area 43 such as an incorporated hard disk or memory.

### ONE EXAMPLE OF WARNING PROCESS SERVING AS ONE EMBODIMENT OF THE INVENTION

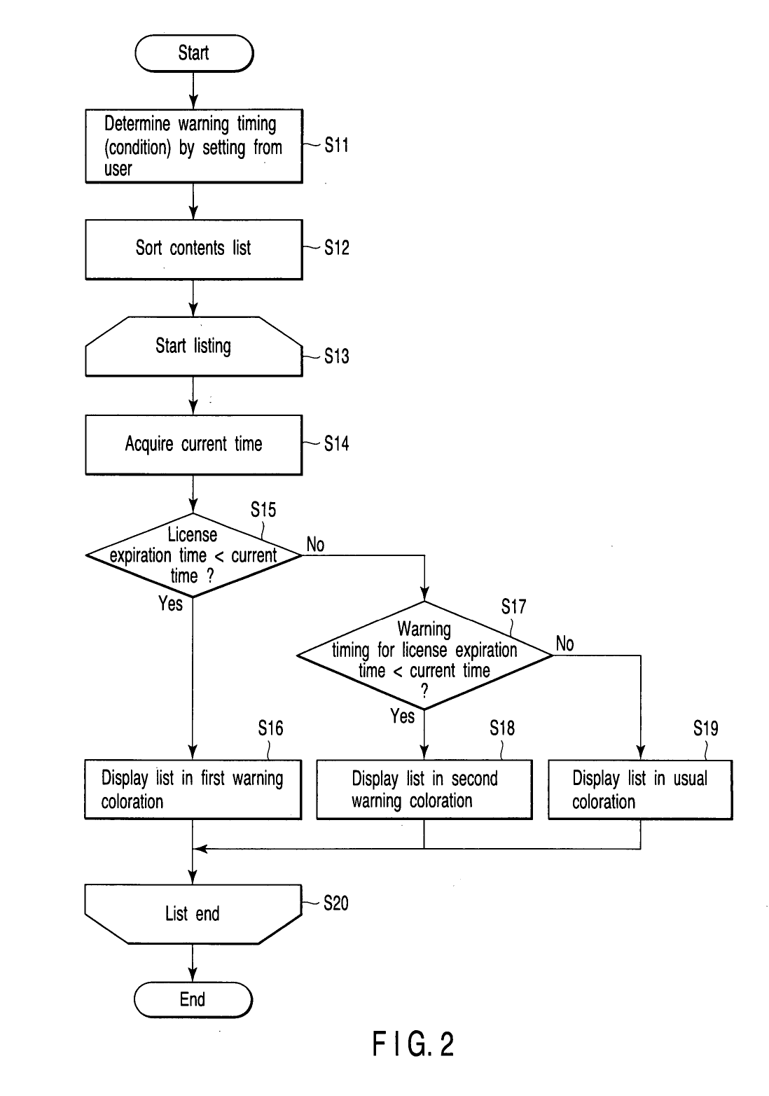

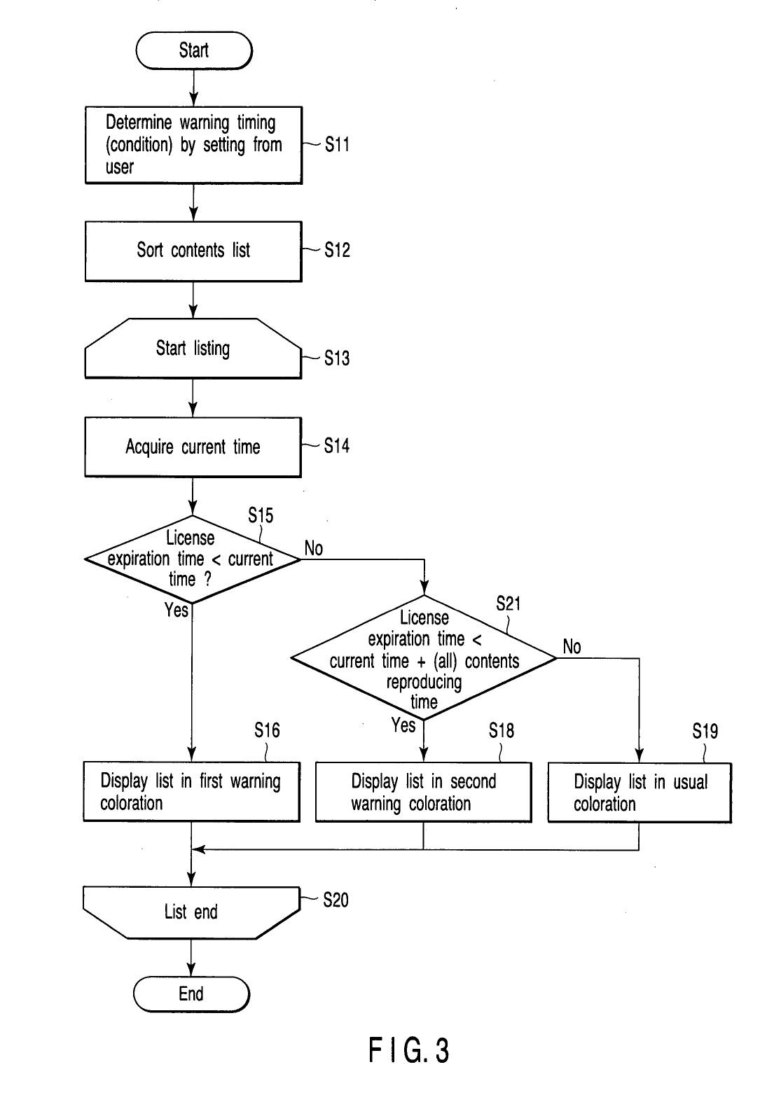

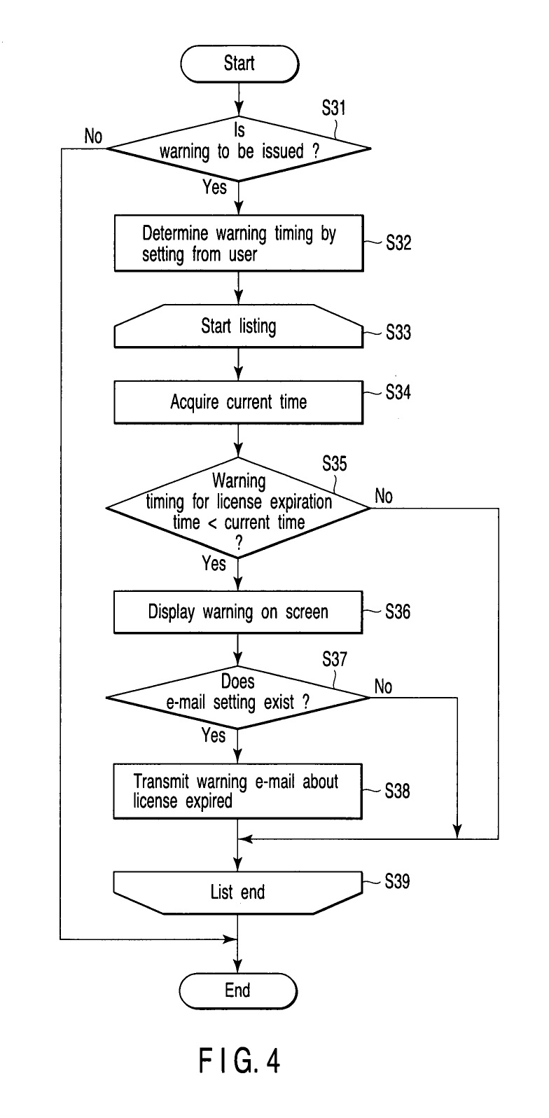

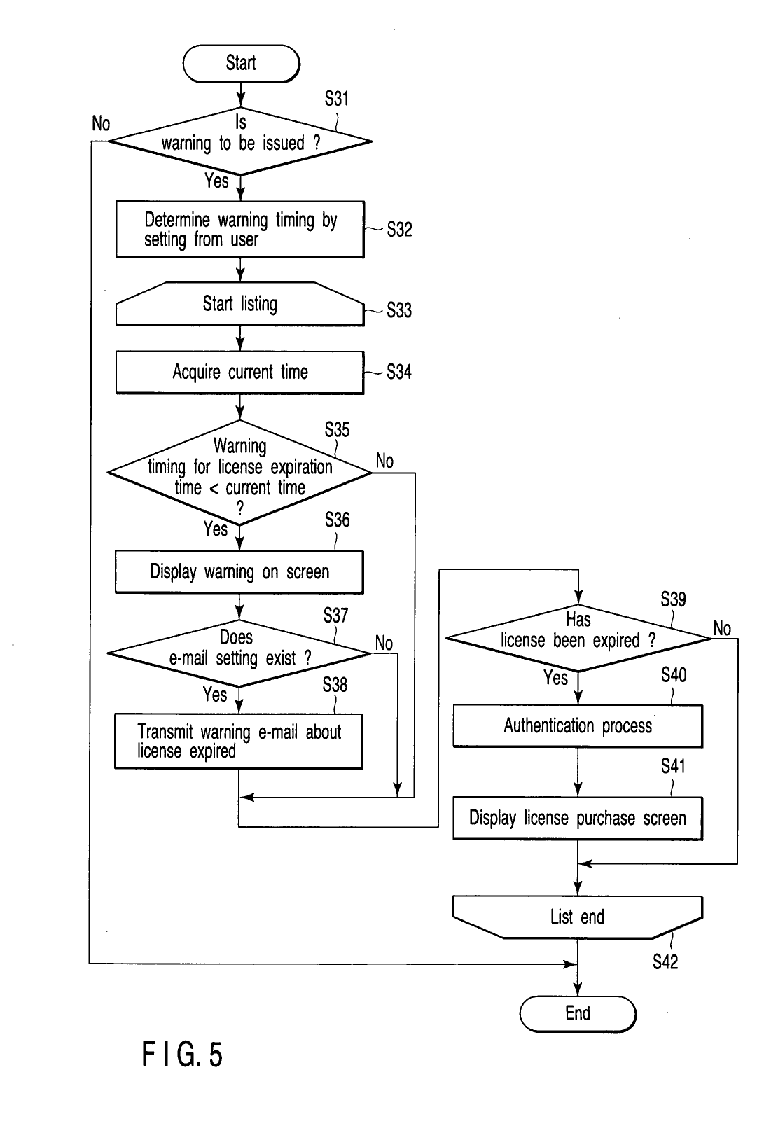

Hereinafter, one example of warning process as one embodiment of the present invention will be descried in detail with reference to the drawings. FIGS. 2 and 3 are flowcharts showing examples of warning process for fixed-term contents of the reproducing apparatus according to one embodiment of the present invention. FIG. 4 is a flowchart, in the same way, showing an example of warning process using e-mail. FIG. 5 is a flowchart, in the same way, showing an example of another warning process with a screen for purchasing fixed-term contents.

Note that the following respective steps in the flowcharts of FIGS. 2 to 5 can be replaced with circuit blocks, and therefore, all the steps in the respective flowcharts can be redefined as blocks.

### Summary

A video-on-demand (hereinafter VOD) service using a broadband line has been in widespread use. As the advantage in the VOD service, it is possible to view contents whenever a user wishes to view those, and further to purchase and view only contents that the user wishes to view.

However, because the licenses of purchased contents are managed by a server side, in order to confirm how long the purchased contents can be viewed at a reproducing apparatus side, there is a method of viewing the same contents again.

However, for example, the method has not necessarily satisfied the demands of users who want to know whether or not it is possible to view the content until the end in the case where the users start viewing a fixed-term content from a current time. Accordingly, in the following embodiment, a warning indication or the like is autonomously displayed inside a television apparatus on the basis of a warning condition optionally provided from a user.

### Warning Indication on Contents List (FIG. 2)

This embodiment of the invention is first to store a license expiration time of a content purchased by a user at the reproducing apparatus side to be presented to the user, and further to issue a warning notification to the user when the license expiration time is approaching.

As shown in the flowchart of FIG. 2, a variety of information such as whether or not to issue a warning and how to decide a warning condition (timing) are provided from the operating unit 32 or the like operated by a user, and the control unit 30 and the contents management unit 42 set the information (step S11).

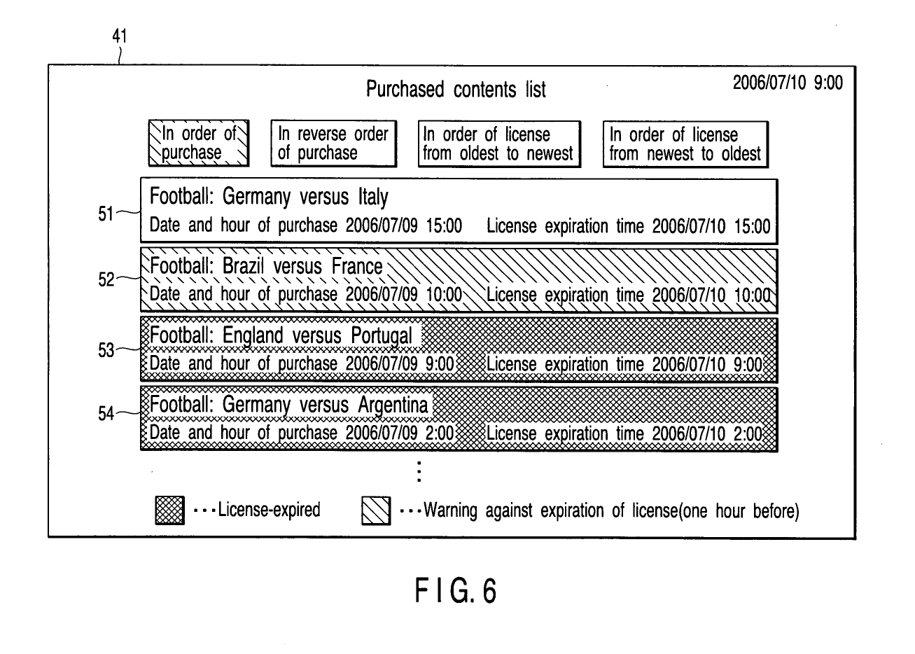

Further, FIG. 6 is an explanatory drawing showing an example of a contents list screen which the reproducing apparatus displays. The list of purchased contents can be displayed in several formats selected by a user as shown in FIG. 6. For example, it is displayed in order of purchase, in reverse order of purchase, in order of license expiration time from oldest to newest, and in order of license expiration time from newest to oldest. The selective formats are displayed on the screen, and a format which is currently selected by the user is displayed so as to be color coded into at least three types such as areas 51, 52, 53, and 54.

Then, process for sorting factors of the stored purchased contents list is performed in accordance with the format selected by the user (step S12). The following processes are started with respect to each of the sorted factors of the list (step S13).

First, acquisition of a current time is carried out (step S14). Next, a license expiration time of the stored purchased content and the current time are compared. When the current time shows that the license expiration time is expired, and it is absolutely impossible to view the content (step S15), the information on the content is described in the areas 53 and 54 of a first warning coloration different from a usual coloration (step S16).

When the current time is before the license expiration time, a time calculated on the basis of a warning notification timing set by the user and the license expiration time is compared with the current time. When the current time is past the calculated time, as shown in FIG. 6, the information on the content is described in the area 52 of a second warning coloration different from the usual coloration.

Here, the warning notification timing (warning condition) set by the user is, for example, “whether there is an hour or more to view the content”, or “whether it is possible to view the content until the end in the case where content is started to be viewed from a current time”, and any other warning condition is possible.

Namely, in the case where the license expiration time is July 10th, 10:00 and the current time is July 10th, 9:00, this case meets the warning condition “whether there is an hour or less to view the content”. Thus, the content is described in the area 52 of the second warning coloration.

Further, in the case where the reproducing time of the content takes two hours, the license expiration time is July 10th, 10:00 and the current time is July 10th, 9:00, the case meets the warning condition “whether it is impossible to view the content until the end in the case where the content is started to be viewed from a current time”. Thus, the content is described in the area 52 in the second warning coloration.

Further, current date and hour are indicated at a position at which the displaying of the display unit 41 shown in FIG. 6 is not obstructed.

Further, when it is possible to view the content, the content is described in the area 51 of the usual coloration (step S19). Such processes are repeatedly performed with respect to all the contents (step S20), which makes it possible to issue a warning of the areas of a plurality of colors in the contents list as shown in FIG. 6.

### Warning Indication on Contents List (FIG. 3)

Moreover, the case of the flowchart of FIG. 3 is described by the same processes as those in the flowchart of FIG. 2, and descriptions of the common portions will be omitted. However, at step S21, a warning notification timing (warning condition) is “whether it is impossible to view all of a plurality of fixed-term contents stored in the storage unit 43 in the case where the contents are started to be viewed from a current time”.

Namely, when the total time of viewing three fixed-term contents is three hours, those contents will be subject to the warning in the case where there is not three hours or more from a current time to the expiration time for viewing the fixed-term contents.

In this way, it is possible to acquire expiration time information and warning information which a user indeed wishes to know in accordance with a warning condition provided from the operating unit 32 or the like by the user.

### Warning Indication on Reproducing Screen (FIG. 4)

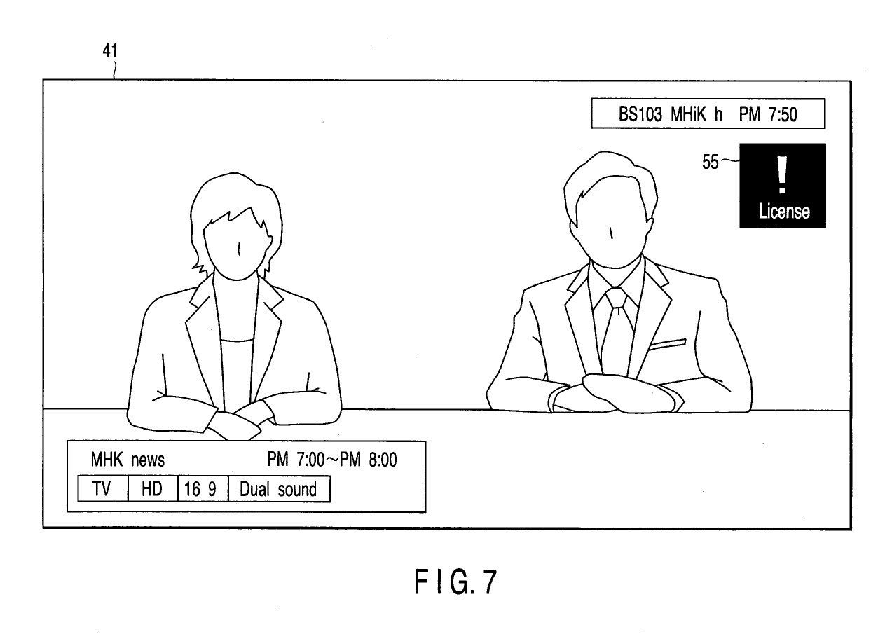

Next, as a way of issuing a warning to a user, a method for issuing a warning by indicating a warning icon 55 in the screen during the reproduction of pictures of a program from the tuner 12 or 13 as shown in FIG. 7, will be specified. Further, a method for notifying a user of a warning by using a mail function provided to the communication unit 11 will be described.

Namely, in the flowchart of FIG. 4, the control unit 30 and the contents management unit 42 judge whether or not the user has set so that a warning is notified before a license expiration time of a purchased content is expired (step S31). Then, when a warning is notified, the timing thereof is to be set, and the contents management unit 42 stores the set value (step S32).

With respect to each of the stored factors of the purchased contents list, the control unit 30 and the contents management unit 42 start the following processes (step S33).

Namely, it is judged whether or not a warning notification is set. When a notification is carried out, the control unit 30 and the contents management unit 42 acquire a current time (step S34). Then, a time calculated on the basis of the license expiration time of the stored purchased content and a warning notification timing set by the user is compared with the current time (step S35). When the current time is past the calculated time, a warning indication is described on the display unit 41 as shown in FIG. 7. However, it may be in conjunction with a warning sound, or may be only a warning sound (step S36). As a warning indication, the warning icon 55 is preferable.

Next, when a warning notification is set to be transmitted by an e-mail (step S37), a warning message, and a name and a license expiration time of the purchased content are transmitted to a destination address of the user set in advance by using the mail function or the like of the communication unit 11 (step S38).

In this manner, since it is possible for the user to know in advance that the expiration time of the content will be expired even when the user is viewing another broadcast program, it is possible to issue an appropriate warning on the demand of the user.

### Warning Indication on Reproducing Screen (Purchase Screen) (FIG. 6)

Next, to cope with a case in which a license is expired, it is preferable to automatically display a screen for purchasing a license.

Namely, FIG. 5 is described by steps substantially the same as those in the flowchart of FIG. 4, and descriptions of the same portions will be omitted. However, at step S39, the expiration of the license is periodically checked from start to end of the content being viewed by the functions of the control unit 30 and the contents management unit 42. Then, when the expiration of the license is recognized, the control unit 30 and the contents management unit 42 read an address leading to a license purchase screen from an address storage area, and the license purchase screen is preferably displayed on the display unit 41 (step S41). Such processes are repeated with respect to all the factors in the list (step S42).

In this manner, it is possible for the user to smoothly repurchase the content that the user wishes to view without a break even after the expiration of the license, and to view the desired content without confusion.

Note that, in the embodiment described above, the example of the television apparatus with the display screen has been described. However, an object serving as an apparatus to which the present invention can be applied is not limited to a television apparatus with a display screen, and may be a tuner apparatus or a personal computer having a VOD function in the same way.

In accordance with the various embodiments described above, those skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A reproducing apparatus comprising:
a communication unit which receives a fixed-term content from an external device via a network;
a storage unit which stores the fixed-term content in a storage area via the communication unit;
an input unit which inputs a warning condition; and
a management unit which compares an expiration time of the fixed-term content stored in the storage unit with a current time, and which generates a warning image or a warning sound to be output when a time from the current time to the expiration time satisfies the warning condition input from the input unit.

2. The reproducing apparatus according to claim 1, wherein the management unit issues a warning when it is impossible to reproduce the fixed-term content from the current time to the end of a reproducing time.

3. The reproducing apparatus according to claim 1, wherein the management unit issues a warning when it is impossible to reproduce a plurality of fixed-term contents stored in the storage unit from the current time to the ends of respective reproducing times.

4. The reproducing apparatus according to claim 1, wherein the management unit issues a warning with a plurality of types of warning images or warning sounds on a contents list screen of a plurality of fixed-term contents stored in the storage unit.

5. The reproducing apparatus according to claim 1, wherein the management unit generates a plurality of types of warning images different from one another in coloration.

6. The reproducing apparatus according to claim 1, wherein a warning is issued by indicating a warning image for the fixed-term content on a dynamic image screen different from that of the fixed-term content.

7. The reproducing apparatus according to claim 1, wherein the management unit acquires and supplies a license purchase screen relating to contents irreproducible because expiration times are expired, with respect to the fixed-term content to which the warning has been issued.

8. A reproducing method comprising:
receiving a fixed-term content via a network and storing the content;
inputting a warning condition; and
comparing an expiration time of the fixed-term content with a current time, and issuing a warning with a plurality of types of warning images or warning sounds on a contents list screen of a plurality of fixed-term contents when a time from the current time to the expiration time satisfies the warning condition.

9. The reproducing method according to claim 8, further comprising comparing an expiration time of the fixed-term content with a current time, and issuing a warning with a warning image or a warning sound for the fixed-term content on a dynamic image screen different from that of the fixed-term content when a time from the current time to the expiration time satisfies the warning condition.

10. A reproducing system comprising:
a communication unit which receives a fixed-term content from an external device via a network;
a storage unit which stores the fixed-term content in a storage area via the communication unit;
an input unit which inputs a warning condition;
a management unit which compares an expiration time of the fixed-term content stored in the storage unit with a current time, and which generates a warning image or a warning sound to be output when a time from the current time to the expiration time satisfies the warning condition input from the input unit; and
a display unit which displays the fixed-term content received by the communication unit and the warning image from the management unit.
